(19) United States
(12) Patent Application Publication
(10) Pub. No.: US 2022/0018426 A1
(43) Pub. Date: Jan. 20, 2022

(54) LAUNCH DEVICE COMPONENT ASSEMBLY AND RETENTION FEATURE

(71) Applicant: EXEDY GLOBALPARTS CORPORATION, Belleville, MI (US)

(72) Inventor: Daniel Leschuk, Chelsea, MI (US)

(21) Appl. No.: 17/293,443

(22) PCT Filed: Nov. 11, 2019
(86) PCT No.: PCT/US2019/061269

§ 371 Date: May 12, 2021

Related U.S. Application Data
(60) Provisional application No. 62/760,605, filed on Nov. 13, 2018.
(60) Provisional application No. 62/780,787, filed on Dec. 17, 2018.

(51) Int. Cl. F16H 45/02; F16H 41/24

(52) U.S. Cl. CPC F16H 45/02; F16H 2045/002; F16H 2045/0221; F16H 41/24

(57) ABSTRACT

A launch device for rotationally coupling a prime mover to a transmission. The launch device includes a front and rear cover cooperating to define a chamber into which a plurality of blades extend forming an impeller. Located in the chamber and fluidically coupled to and rotationally driven by the impeller is a turbine. One or more roller bearings support the turbine and the rear cover for rotation about a central axis. The bearings include inner and outer members supporting the roller elements. A retention feature is further provided to aid in installation and retention of a support component with the bearing. The retention feature allows relative movement in an axial direction of assembly until the bearing and support components are fully engaged, but inhibits relative movement of the bearing and support components in an opposing axial direction.

### BACKGROUND

### 1. Field of the Invention

The present invention generally relates to a launch device used in connection with the powertrain of a vehicle. More specifically, the invention relates to an assembly and retention feature for components of a launch device, such as a torque converter, used in connection with the automatic transmission of an automotive vehicle.

### 2. Description of Related Art

Generally, vehicles with automatic transmissions utilize a torque converter, or launch device, to couple the output of the engine or motor with the input of the automatic transmission. The torque converter includes a front cover that is connected to the flex plate of the engine/motor. The front cover rotates with the flex plate and is in turn connected to a back cover of the torque converter. The back cover causes rotation of the torque converter's impeller (or pump). To drive the impeller, the back cover may be unitarily or integrally formed with the impeller.

The impeller includes blades (or vanes) and its rotation drives a fluid retained within the shell defined by the front and rear covers. Driven by the impeller, the fluid is transferred to the blades of a turbine, and this transfer in turn causes rotation of the turbine. Finally, the rotational output of the turbine is coupled to the input of the automatic transmission.

To enable torque multiplication, a stator is located between the impeller and the turbine. The stator, which is mounted on a one-way clutch, redirects fluid from the turbine back to the impeller. This redirection of the fluid is conducted in such a manner that it results in a multiplication of the torque.

Presented in FIG. 1 is a torque converter of a construction similar to that discussed above. The torque converter 900 of FIG. 1 includes a front cover 902 with mounting studs 904 (or weld nuts, not shown) secured to cover's exterior surface. The studs 904 are used to mount the torque converter 900 to the flex plate (not shown) of an engine or motor (also not shown). At its periphery, the front cover 902 is secured to a rear cover 906 by a weld 908 or other mechanism.

Internally, the rear cover 906 is provided with a series of blades or vanes 910 so as to form the impeller 912. During rotation of the impeller 912, hydraulic fluid received through flow paths (not designated) from the automatic transmission (not shown) is centrifugally forced outward, then forward to impact against opposing blades 914 of the turbine 916. In FIG. 1, outward motion of the fluid is toward the top of the figure and forward motion of fluid is toward the left of the figure.

The shape of the turbine's blades 914 causes both rotation of the turbine 916 and redirection of the fluid. This redirection is both inward and back to the impeller 912. The turbine is also mounted to a hub 918, which is in turn mounted to an input shaft (not shown) of the automatic transmission.

Positioned between the lower portions of the blades 914 of the impeller 912 and turbine 916 is a stator 920. The stator 920 receives hydraulic fluid being returned to the impeller 912 and redirects the fluid. This redirection is conducted in such a manner that it does not impede rotation of the impeller 912.

Forward of the turbine 916, between the turbine 916 and the front cover 902, the torque converter 910 also includes a rotational damper 922 and a lockup clutch assembly 924, of which the lockup clutch assembly 924 is forward most on the engine side of the torque converter 900.

Relative rotation between hubs of the rear cover 906, turbine 916 and the rotational damper/lockup assembly 922, 924 is provided in the torque converter 900 by axial thrust bearings 926, which may include either roller balls or cylinders as the rolling elements.

During operation of the torque converter 900, as the engine speed increases, the fluid pressure inside the torque converter similarly increases. Along with the increased fluid pressure, the hydrodynamic function of the fluid coupling between the impeller 912 and the turbine 916 causes the components within the torque converter to experience a thrust load and to axially separate. This separation in turn causes the overall package of the torque converter shell to expand or balloon. The expansion must be accommodated on both the engine and transmission sides of the torque converter. Illustratively, if torque converter may expands 2 mm, a total of 4 mm of axial expansion would need to be accounted for in protecting the torque converter.

To control this expansion, the front and rear covers 902, 906 have typically been provided with a thickness that limits overall expansion to a design specification, which in the above illustrative example would be not more than 2 mm. The specific thickness of the front and rear covers accordingly will depend on the particular application in which the torque converter is used and expansion associated therewith. In all applications, however, increased thickness increases both the weight and the package size of the torque converter, which is contrary to the design optimization of the torque converter.

### SUMMARY OF THE INVENTION

As discussed herein, a launch device construction is provided that allows for light weighting and package size reduction while still controlling the expansion of the launch to not more than 2 mm. Through the provided construction, expansion of the torque converter can be controlled while allowing for a decrease in the thickness of the front and rear covers, resulting in the above-mentioned weight and package size reduction.

In one aspect of the invention, a launch device is provided for coupling together the rotary output member of a prime mover and the rotary input member of a transmission

In another aspect, the launch device includes a front cover configured to connect to the rotary output member of the prime mover, a rear cover connected to the front cover and rotatable therewith, the front and rear covers cooperating to define a chamber, one of the front and rear covers integrally or unitarily defining an impeller having a plurality of impeller blades extending into the chamber, a turbine having a hub configured to be connected to the rotary input member of the transmission, the turbine integrally or unitarily including a plurality of turbine blades generally opposing the impeller blades, the impeller blades being shaped to direct a fluid contained within the chamber toward the turbine, and the turbine blades being shaped to redirect the fluid back toward the impeller blades; at least one bearing rotationally supporting one of the turbine and the rear cover for rotation about a central axis, the bearing including a rolling element and inner and outer members supporting the rolling element, and a retention feature including resilient teeth extending in a radially angled direction relative to a first axial direction and allowing in the first axial direction assembling of the bearing to a supporting structure within the launch device, the teeth preventing disassembling of the bearing and the support structure in a second axial direction that is opposite to the first axial direction.

In a further aspect, the radially angled direction of the teeth extends one of toward and away from a central axis of the launch device.

In an additional aspect, the retention feature includes a locking ring mounted on one of the bearing and the supporting structure, the locking ring further including a ring portion and the teeth extending from the ring portion.

In yet another aspect, the teeth are deflectable toward the one of the bearing and the supporting structure on which the locking ring is mounted.

In still a further aspect, the teeth engage the other of the bearing and the supporting structure.

In an additional aspect, the ring portion is received in a groove defined in a portion of the bearing.

In still another aspect, the ring portion is received in a groove defining in a portion of the supporting structure.

In yet a further aspect, the teeth engage a groove defined in a portion of the bearing.

In yet an additional aspect, the teeth engage a groove defined in a portion of the supporting structure.

In another aspect, the teeth engage a surface of the bearing.

In a further aspect, the surface of the bearing is a modified surface increasing the coefficient of friction between the surface and the teeth.

In yet an additional aspect, the teeth engage a surface of the supporting structure.

In another aspect, the surface of the supporting structure is a modified surface increasing the coefficient of friction between the surface and the teeth.

In a further aspect, the supporting structure is one of the hub supporting the turbine, the front cover, the rear cover, the alignment stub engaging the front cover, or an inner race of a one-way clutch assembly.

In still an additional aspect, the bearing is a roller bearing.

In another aspect, the inner and outer members are inner and outer races of the roller bearing.

In a further aspect, the bearing is a ball bearing.

In an additional aspect, the bearing is a needle bearing.

In another aspect, the bearing is a needle roller thrust bearing.

In a further aspect, the inner and outer members are cap carriers, the cap carriers including circumferentially extending axial and radial portions.

In another aspect of the invention, a launch device is provide having a front cover configured to connect to the rotary output member of the prime mover, a rear cover connected to the front cover and rotatable therewith, the front cover and the rear cover cooperating to define a chamber, one of the front and rear covers integrally or unitarily defining an impeller having a plurality of impeller blades extending into the chamber, a turbine having a hub configured to be connected to the rotary input member of the transmission, the turbine integrally or unitarily including a plurality of turbine blades generally opposing the impeller blades, the impeller blades being shaped to direct a fluid contained within the chamber toward the turbine, and the turbine blades being shaped to redirect the fluid back toward the impeller blades, at least one bearing rotationally supporting one of the turbine and the rear cover for rotation about a central axis, the bearing including a rolling element and inner and outer members supporting the rolling element; and a retention feature allowing for assembly of the bearing to a supporting structure within the launch device in a first axial direction, the retention feature preventing disengagement of the bearing and the support structure in a second axial direction that is opposite to the first axial direction.

In another aspect of the invention, a launch device is provided having a front cover configured to connect to the rotary output member of the prime mover, a rear cover connected to the front cover and rotatable therewith, the front cover and the rear cover cooperating to define a chamber, one of the front and rear covers integrally or unitarily defining an impeller having a plurality of impeller blades extending into the chamber, a turbine having a hub configured to be connected to the rotary input member of the transmission, the turbine integrally or unitarily including a plurality of turbine blades generally opposing the impeller blades, the impeller blades being shaped to direct a fluid contained within the chamber toward the turbine, and the turbine blades being shaped to redirect the fluid back toward the impeller blades, at least one bearing rotationally supporting one of the turbine and the rear cover for rotation about a central axis, the bearing including a rolling element and inner and outer members supporting the rolling element; and a self-adjusting retention feature allowing for axial movement of the bearing relative to a supporting structure in a first axial direction and preventing movement the bearing relative to the support structure in a second axial direction that is opposite to the first axial direction, whereby as components of the launch device wear and clearance between the components increases axial load reversals on the bearing cause movement of at least portion of the retention in the first direction reducing the clearance.

In one aspect of the invention, a quick and durable retaining feature is provided for assembly of the components of the launch device.

### BRIEF DESCRIPTION OF THE DRAWINGS

FIG. 1 is an axial cross-sectional view of a torque converter in accordance with a known construction.

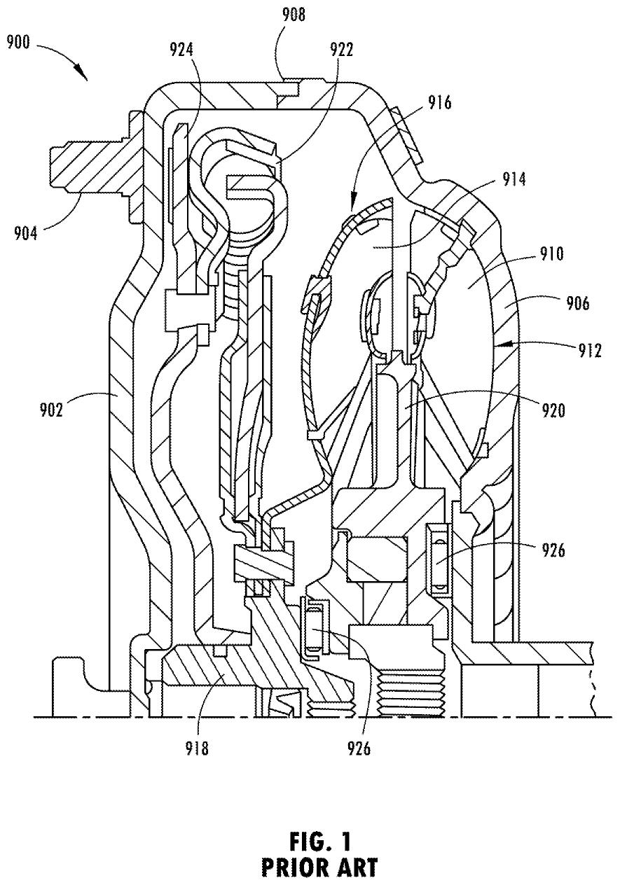

FIG. 2 is an axial cross-sectional view of a launch device in accordance with the principles of the present invention.

FIG. 3 is an axial cross-sectional view of a variation of the launch device seen in FIG. 2.

FIG. 4 is an axial cross-sectional view of a variation of the launch device seen in FIG. 3 embodying a retaining feature embodying the principles of the present invention and providing for easy assembly of the components of the launch device.

FIG. 5 is an axial cross-sectional view of another variation of the launch device embodying the principles of the present invention.

FIG. 6 is an enlarged schematic illustrations of one embodiments of a retention feature embodying the principles of the present invention.

FIG. 7 is an enlarged schematic illustrations of one embodiments of a retention feature embodying the principles of the present invention.

### DETAILED DESCRIPTION

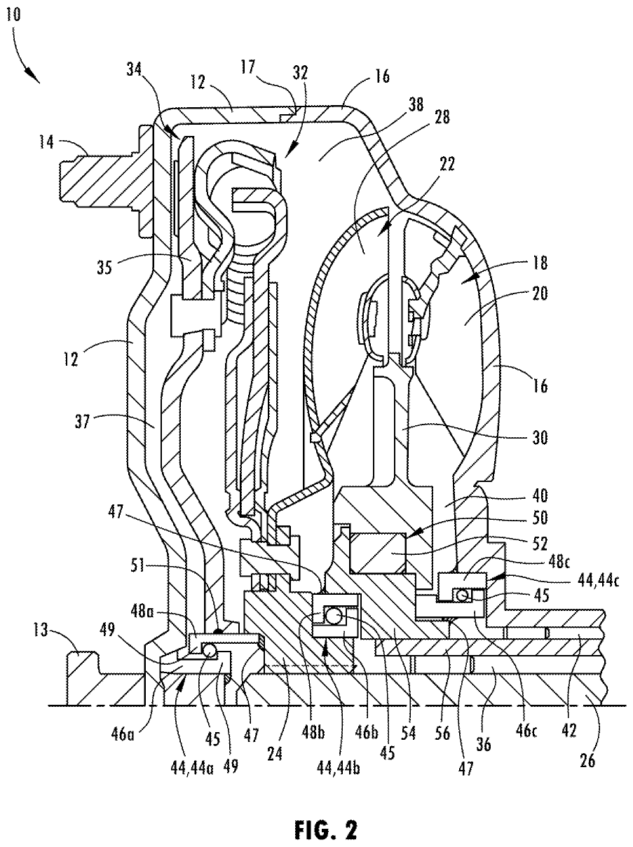

Referring now to the drawings, the principles of the present invention are generally illustrated FIGS. 2-7. The description that follows may use directional terms such as “upper” and “lower.” These terms are intended to be read in the context of the orientation of the elements as presented in the drawings. Accordingly, “upper” indicates a direction toward the top of the drawing and “lower” indicates a direction toward the bottom of the drawing. The term “forward” indicates a direction to the left of the drawing and the term “rearward” indicates a direction the right of the drawings. The terms “inward” or “inner” and “outward” or “outer” indicate a direction that is generally toward or away from a central axis of the referred to part, whether or not such an axis is designated in the drawing. Accordingly, an axial surface is one that faces in the axial direction (i.e. in a direction along the axis). In contrast, a radial surface therefore faces radially, generally away from or toward the axis. It will be understood, however, that these relative terms are for convenience of description.

Terms concerning attachment of structures and components, such as “coupled,” “attached,” “connected,” “joined,” “mounted” or “interconnected” refer to a relationship where the structures are secured or attached to one another either directly or indirectly through an intervening structure, unless specifically indicated otherwise. These attachments and relationships may be movable or rigid, unless indicated otherwise. “Integral” means that multiple elements are connected together so as to form one unit. “Unitary” means a single, one piece element. Thus, the term “unitary” is to be distinguished from the term “integral.”

Referring now to FIG. 2, a launch device is generally illustrated therein and designated at 10. The launch device 10 includes a front cover 12 having mounting studs 14, or similar features, spaced about its periphery and configured to connect the launch device 10 to a flex plate or outlet of a prime mover (neither of which is shown), such as motor, including without limitation internal combustion engine and electric motors. Also at its radial periphery, the front cover 12 is secured to a rear cover 16 by a weld 17 or other mechanism. The front cover 12 defines the engine side of the launch device 10, while the rear cover 16 defines the transmission side of the launch device 10. As the flex plate is rotated by the crankshaft (not shown) of the prime mover, the front cover 12 and rear cover 16 are rotated in unison therewith.

Internally, the rear cover 16 is integrally provided with a series of blades or vanes 20 so as to form an impeller 18. During rotation of the rear cover 16, and therefore the impeller 18, hydraulic fluid supplied from the automatic transmission along a first pathway is forced radially outward under the centrifugal force of the rotating impeller 18 and blades 20. The shape of the blades 20 and the inner surface of the rear cover 16 also causes the hydraulic fluid to be directed forward, in the direction of front cover 12. In FIG. 2, outward motion of the fluid is toward the top of the figure.

Immediately forward of the impeller 18, the launch device 10 includes a turbine 22. The turbine 22 is mounted to a hub 24, and the hub 24 is connected to a rotatable input shaft 26 of the automatic transmission of the automotive vehicle. As seen in FIG. 2, the connection between hub 24 and input shaft 26 is illustrated as a splined engagement.

Similar to the impeller 18, the turbine 22 also includes a series of blades 28. The outward portion of the turbine's blades 28 are oriented to receive the hydraulic fluid from the impeller 18. The combination of the force of the hydraulic fluid from the impeller 18 and the shape of the turbine's blades 28 drives the turbine 22 in a rotational direction that is the same as the rotational direction of the impeller 18. Hydraulic fluid received by the turbine 22 is then redirected downward and rearward, back toward the impeller 18.

Position between the lower portions of the blades 20 of the impeller 18 and the blades 28 of the turbine 22 is a stator 30. The stator 30 receives the hydraulic fluid being returned from the turbine 22 to the impeller 18. The stator 30 redirects the fluid so that it is in the same rotational direction as the impeller 18. This redirection is conducted in such a manner that it is efficiently received by the impeller 18 and does not impede rotation of the impeller 18. With this fluid coupling, rotation from the output of the engine is transferred as rotation of the input shaft 30 of the automatic transmission.

Integrated with the stator 30 is a clutch assembly 50 that limits the directional rotation of the stator 32 a single direction. The one-way clutch assembly 50 includes an outer race 52, upon which the stator 30 is supported, and an inner race 54. The inner race 54 of the one-way clutch assembly 50 is mounted upon a fixed, nonrotating support shaft 56 associated with the input of the automatic transmission. In the interest of brevity and since one-way clutch assemblies are well known in the technological field of the present invention, the one-way clutch assembly 50 of the present launch device 10 is not illustrated and need not be explained in any greater detail herein. Those skilled in the art will really appreciate the construction and operation thereof.

Forward of the turbine 22, between the turbine 22 and the front cover 12, the launch device 10 includes an isolation damper 32. The isolation damper 32 is commonly mounted to the hub 24 with the turbine 22. The isolation damper 32 absorbs variations in the rotation speed of the front and rear covers 12, 18 to provide for smoother operation of the automatic transmission and the transmission of less vibration to the occupant of the vehicle. Since isolation dampers are also well known in the field of the present invention, the isolation damper 32 of the launch device 10 is not discussed in detail herein, except as necessary.

Between the isolation damper 32 and the front cover 12, the launch device 10 additionally includes a lockup clutch assembly 34. Like isolation dampers, lockup clutch assemblies are well known in the field of the present invention. Accordingly, the lockup clutch assembly 34 is discussed below as necessary, but is not otherwise discussed in significant detail herein.

During operation of the launch device 10, in a clutch open mode, hydraulic fluid is received along one or more passageways (not shown) formed in the input shaft 26 and turbine hub 24, flows through a first bearing 44a and into a chamber 37 located between the piston 35 of the lockup clutch assembly 34 and the front cover 12. During this clutch open mode, pressure in this chamber 37 is greater than chambers elsewhere in the launch device 10, keeping the lockup clutch assembly 34 open.

From chamber 37, fluid flows radially around the piston 35 of the lockup clutch assembly 34 into chamber 38, which is generally defined between the radial sides of the front and rear covers 12, 16 and the turbine 22. Some of this fluid then also passes from chamber 38 into the hydrodynamic torus space between the impeller 18 and the turbine 22. This fluid operates with the impeller 18 and turbine 22 to define a fluid coupling within the launch device 10. Hydraulic fluid also passes from the fluid coupling into pathway 40, through a third bearing 44c and exits the launch device 10 through a passage 42. Flow in the reverse direction initially operates to close the lockup clutch assembly 34. With pressure in chamber 38 between the turbine 22 and piston 35 being greater than pressure in chamber 37, the piston 35 axially moves along an outer race 48a of the first bearing 44a. Once in clutch closed mode, the only flow is leakage or seepage through the lining material of the lockup clutch assembly 34 or various oil seals, such as the seal 51 between piston 35 and the outer race 48a of the first bearing 44a.

It should be noted that the described fluid flow is for the illustrated launch device 10. The exact fluid flow can and will vary based manufacturers and the specific design criteria of their launch device.

As mentioned above, during operation of the launch device 10 the engine speed increases. With this increase in engine speed, the axial forces and thrust loads generated by the hydrodynamic function of fluid coupling, as well as the increased fluid pressure within the launch device 10, will operate to cause axial expansion of the launch device 10.

To control and limit expansion induced by the hydraulic function and increased pressure, the launch device 10 of the present disclosure incorporates what are herein referred to as pull bearings and generally designated at 44. The integrated pull bearings 44 limit and/or prevent axial expansion of the launch devices shell by accepting the axial forces of the hydraulic function and increased pressure.

As seen in FIG. 2, the illustrated embodiment incorporates three pull bearings 44 for accommodating rotation between the various launch device subassemblies. The pull bearings 44 of FIG. 2 are of a ball bearing-type and incorporate ball bearings 45 between inner and outer races 46, 48. The inner and outer races of the pull bearings 44 are configured such that axial pulling on the races 46, 48 will not result in separation of the bearing assembly. Operation of the pull bearings 44 will continue under such forces. This is achieved, in one embodiment by providing each of the races 46, 48 with a radially extending lip 49. The lip 49 defines a race surface capable of bearing against the ball bearing 45 while permitting rolling movement of the ball bearing 45. Accordingly, axial movement is constrained while permitting a continuation of the bearing function. As will be readily appreciated by those skilled in the technological field of this disclosure, the pull bearings 44 may adopt other configurations, including rolling elements of different constructions (e.g. roller, tapered roller, etc.) so long as the above functionality is maintained. The above construction applies to each of the three pull bearings 44 discussed below and is not repeated in the interest of conciseness.

The first bearing 44a is a pull bearing arranged between the front cover 12 and the hub 24 of the turbine 22. More specifically, the outer race 48a of the first pull bearing 44a is non-rotatably fixed to the hub 24 and serves as the inner race of the piston of the lockup clutch assembly 34. The inner race 46a of the first pull bearing 44a is non-rotatably fixed to the front cover 12, either directly or indirectly through other components of the launch device 10, such as an alignment stub 13 fixed to the front cover 12.

A second pull bearing 44b is arranged between the hub 24 of the turbine 22 and the inner race 54 of the one-way clutch assembly 50. Specifically, the outer race 48b of the second pull bearing 44b is non-rotatably fixed to the inner race 54 of the one-way clutch assembly 50, while the inner race 46b of the second pull bearing 44b is non-rotatably fixed to the hub 24.

A third bearing 44c is also a pull bearing and is arranged between the inner race 54 of the one-way clutch assembly 50 and the impeller 18. The inner race 46c of the third pull bearing 44c is non-rotatably fixed to the inner race 54 of the one-way clutch assembly 50, and the outer race 48c of the third pull bearing 44c is non-rotatably fixed to the impeller 18 and/or rear cover 16.

The inner and outer races 46, 48 of the pull bearings 44 maybe mounted on either radial surfaces or axial surfaces of the respectively associated components. Also, the non-rotatably fixation of the inner and outer races (generally 46, 48) may occur on either of these surfaces as well. Non-rotatable fixation may be achieved through a variety of fixation mechanisms, including the use of various mechanical fits or the use of welds. As shown in FIG. 2, welds 47 (only some of which are designated) are used for fixation of all the races of the pull bearings 44, but it will be appreciated that mechanical fits and other fixation means could alternatively be employed.

As a result of the pull bearings 44 and the construction provided herein, the launch device 10 is provided with a mechanism that limits the overall expansion of the launch device 10, while also allowing for the thickness of the front and rear covers 12, 16 to be reduced along with the overall axial packaging requirements of the launch device 10.

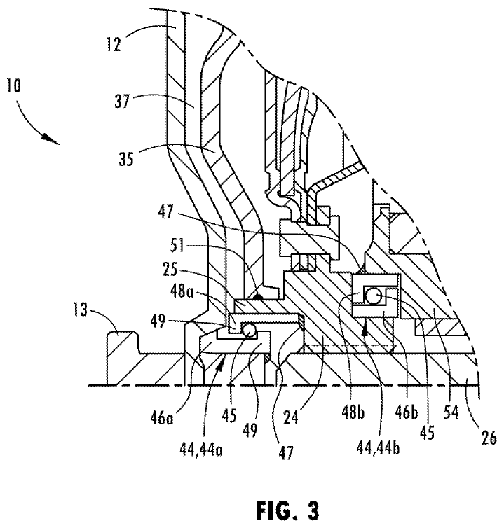

An alternative embodiment of the launch device 10 is seen in FIG. 3. The launch device 10 of FIG. 3 is identical to the launch device 10 of FIG. 2, except for the mounting and support of the piston 35. Instead of the outer race 48a of the first pull bearing 44a serving as the inner race of the piston 35, the hub 24 is provided with and extension 25 circumscribing the outer race 48a of the first pull bearing 44a. The extension 25 of the hub 24 serves as the inner race of the piston 35 of the lock-up clutch assembly 34.

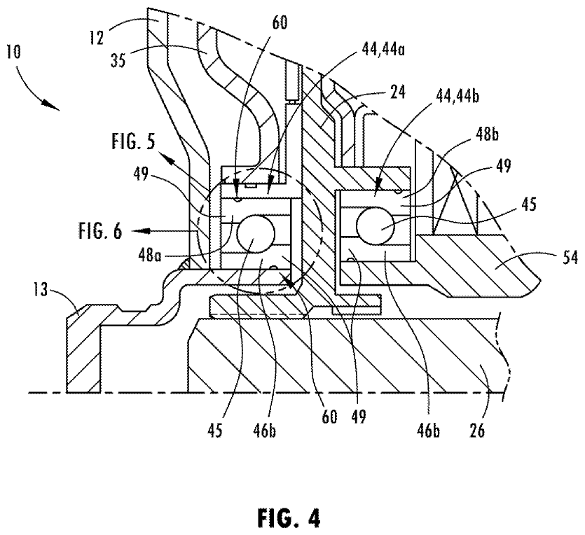

Referring now to FIG. 4, a launch device 10, similar to that seen in FIG. 3, is illustrated therein and incorporates a retaining feature that facilitates assembly of the launch device. Since the various components of the launch device 10 have been significantly discussed in connection with FIGS. 2 and 3, these features are not further discussed in connection with FIG. 4, but corresponding features are identified with corresponding reference numerals.

As seen in FIG. 4, the pull bearings 44 are secured and retained in their assembled positions of the launch assembly 10 by retaining features 60 having a mechanical interacting with the inner and outer races 46, 48 of the pull bearings 44. The retention features 60 are further discussed below.

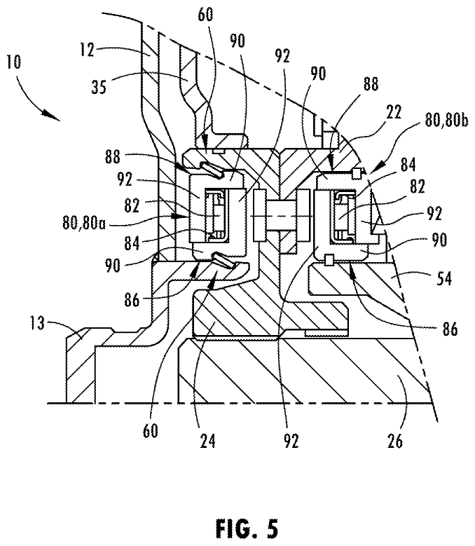

Referring now to FIG. 5, a launch device 10, similar to that seen in FIG. 4, is illustrated therein as also incorporates a retaining feature 60 that facilitates assembly of the launch device 10. Since various components of the launch device 10 seen in FIG. 5 have been already been discussed in connection with FIGS. 2, 3 and 4, a discussion of certain features is not repeated in connection with FIG. 5, but corresponding features are identified with corresponding reference numerals.

The launch device 10 of FIG. 5 incorporates pull bearings generally, designated by reference character 80 of a design differing from the ball bearing design seen in FIGS. 2-4. In FIG. 5, the pull bearings 80 are of needle bearing or needle roller thrust bearing variety so as to enable a reduction in the axial packaging of the launch device 10. The pull bearings 80 therefore include radially oriented needle rollers 82 supported within a cage 84. The cages are further supported between an inner cup carrier 86 and an outer cup carrier 88. The cup carriers 86, 88 each extend circumferentially and, as appreciated when viewed in cross-section in FIG. 5, include axial and radial oriented portions, respectively designated at 90, 92. The inner faces of the radial portions 92 of the cup carriers 86, 88 form the raceways for the needle rollers 82 of the pull bearings 80.

The pull bearings 80 are similarly secured and retained in their assembled positions of the launch assembly 10 by the retention features 60 forming a mechanical interaction with the axial portions 90 of the inner and outer cup carriers 86, 88 of the pull bearings 80.

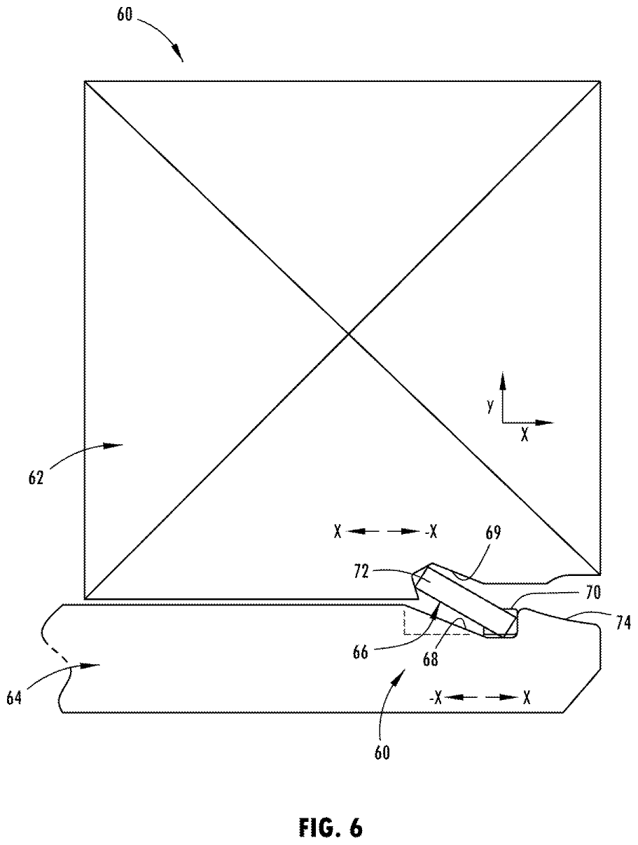

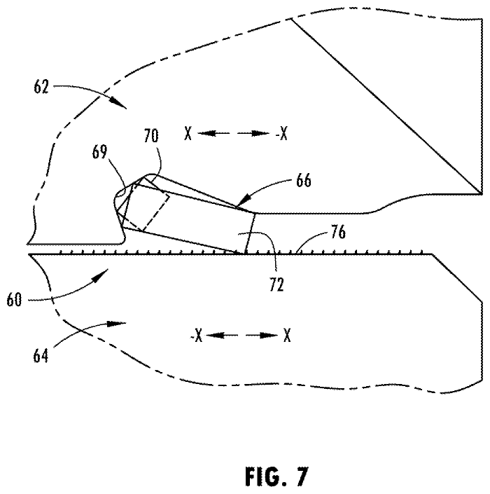

As seen in FIGS. 6 and 7, the retention features 60 utilizes mechanical interference between adjoining components, namely a bearing and its supporting structure, to provide low installation effort during axial assembly of the components, while preventing the adjacent components from separating when a load is applied in the opposite direction after assembly.

Referring now to FIG. 6, schematically illustrated therein, and designated at 62 is a “bearing component” that is representative of the previously mentioned pull bearings or a portion thereof, such as an inner or outer race or as an inner or outer cup carrier. Also seen in FIG. 6 is a support component 64 for the bearing component 62. The support component 64 is representative of the components previously discussed and upon which the previously mentioned inner and outer races or inner and outer cup carriers of the pull bearings are mounted. Accordingly, the support component 64 may be, without limitation, a hub, a portion of a hub, a portion of the front cover, an alignment stub, an inner race of a one-way clutch assembly, or a portion of a rear cover 16.

The retention feature 60 itself incorporates portions of the bearing component 62 and the support component 64, as well as a locking ring 66. Generally, the locking ring 66 is supported in a groove 68, 69 formed in one of the components 62, 64 and includes an annular ring portion 70 having resilient teeth 72 extending therefrom. The resilient teeth 72 are preferably unitary formed with the ring portion 70, but may be integral therewith. The teeth 72 may also extend radially inward or radially outward from the ring portion 70 at an acute angle with respect to a central axis of the launch device 10.

The teeth 72 are angled such that, during assembly of the bearing and support components 62, 64, relative movement between the bearing and support components 62, 64 in an axial direction of assembly causes a radial deflection between the ring 70 and the teeth 72 allowing the inserted component 62, 64 to move over the teeth 72 until the two components are fully assembled. Once the assembled, the teeth 72 prevent movement of the assembled bearing and support components 62, 64 in the opposite direction, thereby retaining the components 62, 64 together.

Prior to assembly of the bearing and support components 62, 64, the locking ring 66 is preferably mounted in a groove 69 formed in the bearing component 64. In this configuration, the ring portion 70 of the locking ring 66 may located in the groove 69, with the teeth 72 extending out of the groove 69 or may be located outside of the groove 69 with the teeth 72 extending into the groove 69. The latter situation is illustrated in FIG. 6. During assembly, the relative movement between the bearing and support components 62, 64 is in the assembly direction X. A leading face 74 of the support component 64 causes the ring portion 70 and the teeth 72 to deflect relative to one another, generally radially. When the bearing and support components 62, 64 reach a fully assembled position, the groove 68 formed in the support component 64 is positioned adjacent to the ring portion 70 and the ring portion 70 resiliently snaps or springs into the groove 68. Because of the snapping of the ring portion 70 into the groove 68, a tactile signal is provided positive engagement and full assembly of the bearing and support components 62, 64 occurs.

Preferably, the leading faces of the grooves 68, 69 in the assembly direction X, are oriented perpendicular to the direction of assembly X to define a stop face and provide resistance to movement in the opposing direction −X. When the direction of the axial load is reversed and in a disassembly direction −X, the teeth 72 of the locking ring 66 engage the leading face of groove 69 and the ring portion 70 engages a corresponding leading face of groove 68, thereby exerting resistive forces on both the bearing component 62 and the support component 64. This results in a column loading effect within the support ring 66 generating a force vector that has both an X and Y component. As the force increases in the disassembly direction −X, a “clamp” force of increasing magnitude is generated in the Y direction, operating to prevent the bearing and support components 62, 64 from separating. Thus, this action works to prevent relative axial movement the bearing and support components 62, 64 out of their fully and properly mounted positions.

Alternatively, the locking ring 66 can be initially mounted in the groove 68 on the support component 64. In this instance, the groove 68 may exhibit a greater depth at its tailing edge (shown in phantom in FIG. 6). In this way, the teeth 72 may be deflected relative to the ring portion 70 into increased depth portion of the groove 68 by the associated surface of the bearing component 62 and then resiliently snap into the groove 69 of the bearing component 62 when the components 62, 64 reach their fully assembled positions relative to one another.

It will be readily appreciated that the relative positions of the ring portion 70 and teeth 72 as seen FIG. 6 may be reversed with the ring portion 70 ultimately residing in the groove 69 of the bearing component 62 and the teeth extending into the groove 68 on the support component 64, similar to the orientation seen in FIG. 7.

Referring now to FIG. 7, illustrated therein is a second embodiment of the retention feature 60. In this embodiment one of the bearing and support components 62, 64 is provided with a groove within which the locking ring 66 is initially mounted and the other of the bearing and support components 62, 64 is provided with a surface 76, machined, etched, formed or otherwise modified to increase the coefficient of friction between the surface 76 and locking ring 66. As presented in FIG. 7, the locking ring 66 is mounted in the groove 69 provided on the bearing component 62, and the machined or formed surface 76 is provided on the support component 64. While this construction is preferred, it may be reversed with the locking ring 66 mounted in a groove, similar to groove 68, provided in the support component 64 and with the machined or formed surface 76 being provided on the opposing surface of the bearing component 62. As further alternative, the locking ring 66 may be so mounted in either of the aforementioned grooves with either the teeth 72 or the ring portion in the groove.

The retention feature 60 of FIG. 7 operates substantially in the same manner as previously discussed in connection with FIG. 6, with the difference being during axial movement in the −X direction an end of the locking ring 66, shown as the end of the teeth 72 in FIG. 7, react with the machined or formed surface 76 instead of with the leading face of a groove.

While not illustrated herein, the retention feature 60 may additionally include features that inhibit relative rotation between the bearing and support components 62, 64. These features may include teeth or depressions formed in the grooves 68, 69 to interact with the teeth 72 of the locking ring and/or additional teeth projecting from the ring portion 70 and generally opposed to the teeth 72.

By integrating the various portions of the retention feature 60 into the bearing races and hub connections of the launch device 10, the complexity and quantity of components can be reduced. Additionally, the proposed construction offers minimal take-up/end play, if any, in the assembled components. This design also offers benefits related to the launch device's one-way clutch. The slip engagement of the retention feature 60 is one-way and can be used to set clutch end play during initial assembly of the launch device 10. As the assembly experiences load reversals (repeated switching in the X and the −X directions), the retention feature can be considered self-adjusting. Also, as the components wear and clearance between the components increases, subsequent load reversals will reduce the clearance as the one-way slip fit of the retention feature 60 will continue to be functional. This has benefits in a launch device application in that the self-adjustability can be used to augment clutch wear, minimizing or preventing an increase in launch device end play. As clutch wear increases, drivability characteristics can suffer because of increased clutch lockup time. The retention feature 60 offers benefits to help mitigate these changes in drivability characteristics and supplement clutch wear by continuously controlling clutch end play through the life of the launch device

As a person skilled in the art will readily appreciate, the above description is meant as an illustration of at least one implementation of a launch device incorporating the principles of the present invention. This description is not intended to limit the scope or application of this invention since the invention is susceptible to modification, variation and change without departing from the spirit of this invention, as defined in the following claims.

1. A launch device for coupling together a rotary output member of a prime mover and a rotary input member of a transmission, the launch device comprising:
a front cover configured to connect to the rotary output member of the prime mover, a rear cover connected to the front cover and rotatable therewith, the front cover and the rear cover cooperating to define a chamber, one of the front and rear covers integrally or unitarily defining an impeller having a plurality of impeller blades extending into the chamber;
a turbine having a hub configured to be connected to the rotary input member of the transmission, the turbine integrally or unitarily including a plurality of turbine blades generally opposing the impeller blades, the impeller blades being shaped to direct a fluid contained within the chamber toward the turbine, and the turbine blades being shaped to redirect the fluid back toward the impeller blades;
at least one bearing rotationally supporting one of the turbine and the rear cover for rotation about a central axis, the bearing including a rolling element and inner and outer members supporting the rolling element; and
a retention feature including resilient teeth extending in a radially angled direction relative to a first axial direction and allowing in the first axial direction assembling of the bearing to a supporting structure within the launch device, the teeth preventing disassembling of the bearing and the support structure in a second axial direction that is opposite to the first axial direction.

2. The launch device according to either of claim 1, wherein the radially angled direction of the teeth extends one of toward and away from a central axis of the launch device.

3. The launch device according to claim 1, wherein the retention feature includes a locking ring mounted on one of the bearing and the supporting structure, the locking ring further including a ring portion and the teeth extending from the ring portion.

4. The launch device according to claim 3, wherein the teeth are deflectable toward the one of the bearing and the supporting structure on which the locking ring is mounted.

5. The launch device according to claim 3, wherein the teeth engage the other of the bearing and the supporting structure.

6. The launch device according to claim 3, wherein the ring portion is received in a groove defined in a portion of the bearing.

7. The launch device according to claim 3, wherein the ring portion is received in a groove defining in a portion of the supporting structure.

8. The launch device according to claim 1, wherein the teeth engage a groove defined in a portion of the bearing.

9. The launch device according to claim 1, wherein the teeth engage a groove defined in a portion of the supporting structure.

10. The launch device according to claim 1, wherein the teeth engage a surface of the bearing.

11. The launch device according to claim 10, wherein the surface of the bearing is a modified surface increasing the coefficient of friction between the surface and the teeth.

12. The launch device according to claim 1, wherein the teeth engage a surface of the supporting structure.

13. The launch device according to claim 12, wherein the surface of the supporting structure is a modified surface increasing the coefficient of friction between the surface and the teeth.

14. The launch device according to claim 1, wherein the supporting structure is one of the hub supporting the turbine, the front cover, the rear cover, the alignment stub engaging the front cover, or an inner race of a one-way clutch assembly.

15. The launch device according to claim 1, wherein the bearing is a roller bearing.

16. The launch device according to claim 18, wherein the inner and outer members are inner and outer races of the roller bearing.

17. The launch device according to claim 15, wherein the bearing is a ball bearing.

18. The launch device according to claim 15, wherein bearing is a needle bearing.

19. The launch device according to claim 15, wherein the bearing is a needle roller thrust bearing.

20. The launch device according to claim 19, wherein the inner and outer members are cap carriers, the cap carriers including circumferentially extending axial and radial portions.

21. A launch device for coupling together a rotary output member of a prime mover and a rotary input member of a transmission, the launch device comprising:
a front cover configured to connect to the rotary output member of the prime mover, a rear cover connected to the front cover and rotatable therewith, the front cover and the rear cover cooperating to define a chamber, one of the front and rear covers integrally or unitarily defining an impeller having a plurality of impeller blades extending into the chamber;
a turbine having a hub configured to be connected to the rotary input member of the transmission, the turbine integrally or unitarily including a plurality of turbine blades generally opposing the impeller blades, the impeller blades being shaped to direct a fluid contained within the chamber toward the turbine, and the turbine blades being shaped to redirect the fluid back toward the impeller blades;
at least one bearing rotationally supporting one of the turbine and the rear cover for rotation about a central axis, the bearing including a rolling element and inner and outer members supporting the rolling element; and
a retention feature allowing for assembly of the bearing to a supporting structure within the launch device in a first axial direction, the retention feature preventing disengagement of the bearing and the support structure in a second axial direction that is opposite to the first axial direction.

22. A launch device for coupling together a rotary output member of a prime mover and a rotary input member of a transmission, the launch device comprising:
a front cover configured to connect to the rotary output member of the prime mover, a rear cover connected to the front cover and rotatable therewith, the front cover and the rear cover cooperating to define a chamber, one of the front and rear covers integrally or unitarily defining an impeller having a plurality of impeller blades extending into the chamber;
a turbine having a hub configured to be connected to the rotary input member of the transmission, the turbine integrally or unitarily including a plurality of turbine blades generally opposing the impeller blades, the impeller blades being shaped to direct a fluid contained within the chamber toward the turbine, and the turbine blades being shaped to redirect the fluid back toward the impeller blades;
at least one bearing rotationally supporting one of the turbine and the rear cover for rotation about a central axis, the bearing including a rolling element and inner and outer members supporting the rolling element; and
a self-adjusting retention feature allowing for axial movement of the bearing relative to a supporting structure in a first axial direction and preventing movement the bearing relative to the support structure in a second axial direction that is opposite to the first axial direction, whereby as components of the launch device wear and clearance between the components increases axial load reversals on the bearing cause movement of at least portion of the retention in the first direction reducing the clearance.
